(19) United States
(12) Patent Application Publication
(10) Pub. No.: US 2018/0205705 A1
(43) Pub. Date: Jul. 19, 2018

(54) NETWORK REQUEST PROXY SYSTEM AND METHOD

(71) Applicant: ARMERON Technologies Ltd., Herzliya (IL)

(72) Inventors: Ron KUPFERSCHMIED, Ganei-Tikva (IL); Tsion GONEN, Baltimore, MD (US)

(21) Appl. No.: 15/407,297

(22) Filed: Jan. 17, 2017

(51) Int. Cl. H04L 29/06; H04L 29/08

(52) U.S. Cl. CPC H04L 63/0281; H04L 63/1408; H04L 67/146; H04L 67/02

(57) ABSTRACT

A method of protecting a web server by applying a trusted web engine (TWE) to execute a webpage code in parallel to a client side web engine (CSWE), comprising a proxy server adapt to use a TWE to execute a code of a webpage provided by a web server, issue to the web server a plurality of trusted requests originating from the TWE, receive a plurality of client side requests originating from a CSWE executing the code of the webpage on a client device in parallel to the TWE, receive from the web server a plurality of responses to the plurality of trusted requests and sending to the CSWE at least some of the plurality of responses synchronized by correlating at least some of the plurality of client side requests with corresponding trusted requests according to identification information injected into the at least some client side requests.

### FIELD AND BACKGROUND OF THE INVENTION

The present invention, in some embodiments thereof, relates to protecting a web server and, more particularly, but not exclusively, to protecting a web server by utilizing a proxy server using a trusted web engine to emulate a client web engine executing webpage code received from the web server.

Web servers providing web services in general and dynamic web content in particular, for example, interactive web pages, web applications and/or the like may be vulnerable to malicious cyber-attacks that may inflict economical and/or reputational damage. The cyber-attacks may include a variety of attack types, for example, redirecting and/or alteration of data, access disruption, credentials compromising and/or the like.

With the constant advances made by cyber criminals, hackers and/or the like employing ever more sophisticated attack methods, means and/or vectors, the measures taken to protect the web servers against the cyber-attacks must also be enhanced.

### SUMMARY OF THE INVENTION

According to a first aspect of the present invention there is provided a computer implemented method of protecting a web server by applying a trusted web engine (TWE) to execute a webpage code in parallel to a client side web engine (CSWE), comprising a proxy server executing a code for:
Using a TWE to execute a code of a webpage provided by a web server.
Issuing to the web server a plurality of trusted requests originating from the TWE.
Receiving a plurality of client side requests originating from a CSWE executing the code of the webpage on a client device in parallel to the TWE.
Receiving from the web server a plurality of responses to the plurality of trusted requests; and
Sending to the CSWE at least some of the plurality of responses synchronized by correlating at least some of the plurality of client side requests with corresponding trusted requests of the plurality of trusted requests according to identification information injected into the at least some client side requests.
   By preventing the client side requests coming in from the CSWE executed by the untrusted client device that may potentially be malicious, the web server is isolated and protected. While the requests directed to the web server originate from the TWE executing the webpage code in parallel to the CSWE the CSWE natively executes the webpage code thus taking advantage of all benefits entailed in the native execution. In addition, the native execution of the CSWE may prevent and/or significantly reduce timing delays and/or execution delays at the CSWE.

According to a second aspect of the present invention there is provided a proxy server for protecting a web server by applying a trusted web engine (TWE) to execute a webpage code in parallel to a client side web engine (CSWE), comprising a program store storing a code and one or more processors coupled to the program store for executing the code, the code comprising:
Code instructions to execute, using a TWE a code of a webpage provided by a web server;
Code instructions to issue to the web server a plurality of trusted requests originating from the TWE to the web application server.
Code instructions to receive a plurality of client side requests originating from a CSWE executing the code of the webpage on a client device in parallel to the TWE.
Code instructions to receive from the web server a plurality of responses to the plurality of trusted requests.
Code instructions to send to the CSWE at least some of the plurality of responses synchronized by correlating at least some of the plurality of client side requests with corresponding trusted requests of the plurality of trusted requests according to identification information injected to the at least some client side requests.

With reference to the first and/or the second aspects of the invention, according to a first implementation, the TWE emulates execution of said code of the webpage by the CSWE according to client information received from the client device. Collecting the client information and providing it to the TWE to execute the webpage code accordingly may significantly improve the accuracy of the webpage code emulation at the TWE as done by the CSWE.

With reference to the first and/or the second aspects of the invention and/or the first implementation, according to a second implementation, the client information comprises one or more members of a group consisting of: an interaction of a user associated with the client device with the code of the webpage, an operational parameter of the CSWE and a configuration parameter of the client device. The emulation of the TWE executing the webpage code using the user interaction with the webpage as well as the operational parameters of the client device and/or the CSWE may significantly improve.

With reference to the first and/or the second aspects of the invention and/or any of the previous implementations, according to a third implementation, each of the plurality of trusted requests and each of the plurality of responses comprises one or more members of a group consisting of: a Hypertext Transfer Protocol (HTTP) method, a protocol, a headers, a body, a Uniform Resource Identifier (URI) path, a URI parameter and a session cookie. The proxy server maintains compliance with the standard web traffic and/or protocols.

With reference to the first and/or the second aspects of the invention and/or any of the previous implementations, according to a fourth implementation, the identification information associated each of the plurality of client side requests with an originating session frame initiated by the CSWE while executing the webpage code. By identifying the frame (i.e. page, window and/or the like), the identification information provides a context for the client side requests to allow the TWE to accurately emulate the webpage code as executed by the CSWE.

With reference to the first and/or the second aspects of the invention and/or any of the previous implementations, according to a fifth implementation, the identification information is injected into the at least some client side requests by embedding the identification information in one or more previous responses sent to the CSWE. The proxy server takes advantage of the responses sent to the CSWE for collecting and providing the identification information to the TWE executing the web page code, the TWE may more accurately emulate the webpage code as executed by the CSWE.

With reference to the first and/or the second aspects of the invention and/or any of the previous implementations, according to a sixth implementation, the identification information is injected into the at least some client side requests by embedding one or more client side scripts in one or more previous responses sent to the CSWE, the one or more embedded client side scripts create the identification information. The proxy server takes advantage of the responses sent to the CSWE to embed client side scripts that may create the identification information which when provided to the TWE executing the web page code may allow the TWE to more accurately emulate the webpage code as executed by the CSWE.

With reference to the first and/or the second aspects of the invention and/or any of the previous implementations, according to a seventh implementation, the identification information is injected into the at least some client side requests by adjusting one or more code segments included in one or more previous response sent to the CSWE, the one or more code segment create the identification information. The proxy server takes advantage of the responses sent to the CSWE to adjust code segment(s) included in the responses such that when executed the adjusted code segments may create the identification information. The created (and collected) identification information may be provided to the TWE executing the web page code to allow the TWE to more accurately emulate the webpage code as executed by the CSWE.

With reference to the first and/or the second aspects of the invention and/or any of the previous implementations, according to an eighth implementation, the identification information is injected into the at least some client side requests by one or more add-on software modules applied to the CSWE, the one or more add-on software modules is initiated to create the identification information. Applying the add-on software module(s) may allow creation and collection of the identification information for one or more client side requests that may otherwise not be traceable by the proxy server. The created (and collected) identification information may be provided to the TWE executing the web page code to allow the TWE to more accurately emulate the webpage code as executed by the CSWE.

Optionally, With reference to the first and/or the second aspects of the invention and/or any of the previous implementations, according to a ninth implementation, one or more cookies provided by the web server to the CSWE are replaced with one or more trusted cookie stored in one or more trusted components records of the proxy server, wherein the identification information further associates the one or more cookies with the trusted cookie. By replacing the cookie(s) with trusted cookie(s), the proxy server may prevent untrusted and potentially malicious cookies from reaching the web server while allowing the CSWE to take advantage of the benefits provided by using the cookie(s).

With reference to the first and/or the second aspects of the invention and/or any of the previous implementations, according to a tenth implementation, one or more text fields included in one or more of the plurality of client side requests is validated by comparing an actual text inserted in the one or more text fields with a text included in the one or more client side requests according to one or more attributes of the one or more text fields, the actual text is collected by monitoring an interaction of a user associated with the client device with the code of the webpage. Since the proxy server may have access to the client information, in particular to the user interaction including test injection, the proxy server may validate that the text included in the client side request fully complies with the actual text inserted by the user. This allows protection of the web server from potential attack vectors that may take advantage of free text fields.

With reference to the first and/or the second aspects of the invention and/or any of the previous implementations, according to an eleventh implementation, one or more client side requests are held by the proxy server until correlated with a corresponding one of the plurality of trusted requests received from the TWE. Since the TWE and CSWE executing the webpage code in parallel may not be fully synchronized, client side request(s) originating from the CSWE may be received at the proxy server before reception of corresponding trusted request(s) originating from the TWE. In order to allow correlation of the client side request(s) with the corresponding trusted requests in scenarios where the TWE lags behind the CSWE, the proxy server allows for a predefined time interval before dropping the client side request(s) having no match, i.e. having no corresponding trusted request(s).

Optionally, With reference to the first and/or the second aspects of the invention and/or any of the previous implementations, according to a twelfth implementation, one or more of the held client side requests are dropped in case the corresponding trusted request is not received from the TWE within a pre-defined timeout period. In order to avoid degradation of the session the CSWE holds with the web server, for example, session prolonging, delayed response, degraded user experience and/or the like, in case the proxy server cannot match the received client side request(s) with corresponding trusted request(s), a predefined timeout period is set such that the respective client side request(s) is dropped if the matching trusted request is not received with the predefined timeout period.

With reference to the first and/or the second aspects of the invention and/or any of the previous implementations, according to a thirteenth implementation, the plurality of trusted requests and the plurality of responses are stored in one or more local records by the proxy server. In order to maintain the flow trusted requests and responses, the proxy server maintains local record(s), for example, a cache, a buffer and/or the like for storing the requests and responses.

Optionally, With reference to the first and/or the second aspects of the invention and/or any of the previous implementations, according to a fourteenth implementation:
Each of the plurality of trusted requests is removed from the one or more local records after responding to one or more client side requests corresponding to the each trusted request
One or more of the plurality of responses associated with each removed trusted requests are removed from the one or more local records.

Removing the responded trusted request and/or the associated responses from the local record(s) may allow the proxy server to maintain locality in time for the responses and/or the requests.

Optionally, With reference to the first and/or the second aspects of the invention and/or any of the previous implementations, according to a fifteenth implementation, one or more constructed trusted requests such as the plurality of trusted requests are issued to the web server. The one or more constructed trusted requests are constructed based on one or more client side requests not emulated by the TWE in case all components of the one or more client side requests correspond to trusted components stored in one or more trusted components records of the proxy server. This may allow the proxy server to serve the CSWE even in scenarios where the client side request(s) cannot be matched with corresponding trusted request(s) originating from the TWE.

With reference to the first and/or the second aspects of the invention and/or any of the previous implementations, according to a sixteenth implementation, the one or more trusted components records include one or more global trusted components used for a plurality of sessions with the web server. The global trusted components are validated for the web server for previous sessions held with the web server and therefore the global trusted components may be safe for use.

With reference to the first and/or the second aspects of the invention and/or any of the previous implementations, according to a seventeenth implementation, the one or more trusted components records include one or more session trusted components used in one or more of the plurality of trusted requests. The session trusted components are validated during previous communication with the web server during the current session and therefore the session trusted components may be safe for use.

With reference to the first and/or the second aspects of the invention and/or any of the previous implementations, according to an eighteenth implementation, the one or more trusted components records include one or more trusted components created according to one or more trusted component creation rules. The session trusted components are created according to rule(s) set by the owner, operator and/or the like of the web server and therefore the rule based trusted components may be safe for use.

With reference to the first and/or the second aspects of the invention and/or any of the previous implementations, according to a nineteenth implementation, the one or more trusted components records is updated to include the one or more constructed trusted requests. Requests constructed according to client side requests are considered trusted and may therefore be stored by the proxy server and compared to one or more subsequent client side requests received from the CSWE to validate the subsequent client side request(s).

With reference to the first and/or the second aspects of the invention and/or any of the previous implementations, according to a twentieth implementation, the proxy server refuses to respond to one or more of the plurality of client side requests in case the one or more client side requests has no corresponding trusted request of the plurality of trusted requests. In case client side request may not be correlated with a corresponding trusted request and/or may not be validated against the trusted components record, the proxy server may refuse the respective client side requests to allow the CSWE to maintain the session.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of an exemplary process for protecting a web server by utilizing a proxy server to execute a trusted web engine, according to some embodiments of the present invention;

FIG. 2A and FIG. 2B are schematic illustrations of first and second embodiments of exemplary systems for protecting a web server by utilizing a proxy server to execute a trusted web engine, according to some embodiments of the present invention;

FIG. 3 is a flowchart of an exemplary process for constructing a trusted request, according to some embodiments of the present invention; and

FIG. 4 is a flowchart of an exemplary process for processing a client side requests received from a client device, according to some embodiments of the present invention, according to some embodiments of the present invention.

### DETAILED DESCRIPTION OF SPECIFIC EMBODIMENTS OF THE INVENTION

The present invention, in some embodiments thereof, relates to protecting a web server and, more particularly, but not exclusively, to protecting a web server by utilizing a proxy server using a trusted web engine to emulate a client web engine executing webpage code received from the web server.

According to some embodiments of the present invention, there are provided methods, systems and computer program products for protecting a web server providing dynamic webpage content, for example, an interactive web page, a web application and/or the like to one or more Client Side Web Engines (CSWE) executed by one or more untrusted client devices used by one or more users. The CSWE executing on the client device(s), for example, a Smartphone, a tablet, a smart watch, a laptop, a desktop, a work station, a server and/or the like issues client side requests such as, for example, Hypertext Transfer Protocol (HTTP) requests to the proxy server to request for updated data following one or more actions taken by a user interacting with the CSWE or programmatic code instruction while executing the webpage's client side code which includes, for example, HTML, JavaScript, CSS and/or the like. The web server is protected through a proxy server that communicates with the CSWE to isolate the web server from the CSWE. The proxy server utilizes a Trusted Web Engine (TWE) executing the dynamic webpage code in parallel (simultaneously) to execution of the webpage code by the CSWE to emulate the CSWE execution flow. Based on the emulation, the proxy server forwards to the web server only requests generated by the TWE, which are considered trusted requests, while preventing all client side request(s) which are untrusted and may potentially be malicious from reaching the protected web server. The proxy server responds to the CSWE with responses received from the web server in response to the trusted requests originating from the TWE thus no direct communication is established between the (untrusted) client device and the web server while the correct behavior of the CSWE is preserved.

In order to accurately emulate the execution flow of the webpage code at the CSWE, the proxy server may collect client information from one or more of the client devices, for example, interaction made by the (associated) user using the client device with the dynamic webpage content, operational information of the CSWE, configuration information of the client device and/or the like. The client information may further include and/or define one or more relevant methods and/or events, for example, user interaction triggers at the CSWE such as, for example, key presses, mouse moves and/or the like. One or more of the methods and/or events may further be associated with a date, a time, a location and/or the like.

Optionally, the proxy server may bypass the real-time use of the TWE and construct valid trusted requests that are semantically similar to the client side request(s) based on trusted request(s) previously generated by the TWE. The previously generated trusted requests may be generated by the TWE during the current CSWE session, during previous session(s) of the CSWE and/or globally (in general) during one or more sessions of one or more CSWEs. The constructed trusted requests may be created using a plurality of trusted components stored in a trusted components record. The trusted components may include, for example, HTTP methods, protocols, headers, bodies, Uniform Resource Identifier (URI) paths (typically expressed as Uniform Resource Locator (URL) paths), URI parameters, session cookies and/or the like. The trusted components record may include global trusted components that may be typically, previously (in the past) and/or generally used components used for communicating with the web server. The trusted components record may also include session specific trusted components used for one or more of the trusted requests during the current session conducted with the web server. In case the client side request(s) is found to have matching components to the trusted components in the trusted components record, the proxy server may use the trusted components to construct trusted request(s) based on the client side request(s) and issue the constructed trusted request(s) to the web server. This prevents forwarding the client side requests generated by the CSWE to the protected web server even when the TWE is not used concurrently with the CSWE and/or when a client side request cannot be matched (correlated) to a corresponding trusted request generated from the TWE.

Optionally, in case the proxy server receives a client side request(s) which could not be matched to a trusted request and/or to trusted component(s) in the trusted components record the proxy will hold the request for a pre-defined time period to allow the TWE to issue a corresponding trusted request. After the pre-defined time period expires the proxy server may refuse the client side request(s).

The proxy server receives from the web server responses to the trusted request and synchronizes the responses to both the TWE and the CSWE by correlating between at least some of the client side requests and the trusted requests. The proxy server may correlate between the client side requests and the trusted requests using identification information (tagging) injected into one or more of the client side requests to identify a context of the client side request(s). The proxy server may then instruct the TWE to apply the same context as used by the CSWE for executing the webpage code thus maintaining a synchronized execution flow of the webpage code between the TWE and the CSWE. The identification information may be injected, appended and/or included in the client side requests using one or more implementations. For example, the proxy server may manipulate one or more of the responses received from the web server to include the identification information that will be used by the CSWE in one or more subsequent client side requests. The proxy server may further include one or more client side scripts, for example, a JavaScript that, when executed by the CSWE, injects the identification information into one or more subsequent client side requests. The identification information may also be injected into the client side requests through one or more add-on software modules, for example, a script, a plug-in, an application, an agent, a process and/or the like applied to the CSWE. The add-on software module(s) may also be provided to the CSWE by the proxy server, for example, embedded in one or more responses to one or more previous client side requests, pre-installed on the CSWE, provided as a Software Development Kit (SDK) to be used by client side application developers or embedded in the CSWE software package.

The responses to trusted requests issued by the TWE are sent to the TWE and duplicated to be sent to a correlated client side request from the CSWE. Responses to trusted requests constructed from the trusted components are sent to the CSWE and duplicated to be sent to the TWE for correlated trusted request(s) if such request(s) arrives in a pre-defined time frame. This allows the TWE and CSWE to run in parallel while still maintaining a full synchronization of code between them.

Using the proxy server to protect the web server may present significant advantages compared to currently existing methods for protecting web servers and web applications. One of the main concerns involved with dynamic web applications is that the web application may be exposed to untrusted client devices that may harm the web server by issuing malicious requests to the web server that could not be identified. The existing methods may typically apply a rule based detection and/or protection logic that may require constant manual updating to adapt to new execution environments and/or changes in the webpage code. Moreover, hacking methods exist that may circumvent the detection and/or protection logic of the web server's existing protection methods which may result in the untrusted malicious request being forwarded to the web server and thus bypassing the protection logic. By completely isolating the web server, i.e. never forwarding client side requests originating from the untrusted client devices as done in some embodiments of the present invention, the web server may be better protected from such malicious attacks.

While some of the existing methods may apply a proxy server to intermediate between the client device and the web server, the existing methods may typically be rule driven. The existing methods may use one or more lists, for example, a white list and/or a black list for identifying invalid and potentially malicious components in the request(s) issued by the client device. The black list may present, for example, client side requests that are invalid and may therefore be blocked while forwarding client side requests not listed in the black list. The white list on the other hand may present client side requests that are valid and may therefore be allowed (forwarded to the web server) while blocking client side requests not listed in the white list. Using the lists, however, may present significant impact on the user experience, a management overhead from technical personnel and/or exhibit limited protection when applied for protecting highly dynamic web applications in which the webpage code may be complex, user interaction intensive, highly dynamic and/or constantly updated and changed by the application provider. By using the TWE for emulating the execution flow as executed by the CSWE, the proxy server may dynamically adapt to cover the plurality of possible execution flows by actually following the user and identify in real-time which of the client side requests are valid and which are not by correlating them to trusted requests from the TWE. Moreover, since only the trusted requests are sent to the web server and no untrusted and potentially malicious client side requests ever reach the web server, the solution is not exposed to traditional bypass and/or evasion techniques embedded in the client side requests.

Some of the existing methods may apply emulation of the web page using proxy web engine to remotely execute the webpage content on behalf of the CSWE and present the outcome of the rendered webpage as a video stream and/or as Hyper Text Markup Language (HTML) commands to the user through the CSWE. However due to the dynamic nature and rich ecosystem of modern web applications, the code complexity and/or intensity of user interaction may lead to significant degradation of the user experience and/or limit the benefits of available features such as, for example, universal cookies used for advertising, interactive animations, etc.

Other existing methods may apply user emulation of the web page remotely in order to determine all possible execution paths. However, the code complexity and/or the high number of interaction options may require executing a significantly large number of possible execution paths to cover all valid options offered by the webpage code. This may lead to further latency in serving the client device and/or to increased computation resources at the proxy server hence this may result in increased cost, power consumption, space and/or the like. Furthermore, such implementations do not take advantage of personalized information of the user available to the CSWE, for example, cookies, favorite lists, history lists and/or the like which are naturally not available to the proxy server and thus might not be able to effectively cover possible execution paths.

By collecting the client information and emulating the execution flow of the webpage code at the CSWE with the same client information as used by the CSWE, the TWE may accurately follow the specific execution flow as the CSWE thus limiting the number of execution paths emulated by the TWE. Emulating the execution flow according to the client information may further allow easy adaptation to specific dynamic webpage code without the need to reconfigure the proxy server. This may also allow the proxy server to adapt automatically to evolution and/or change of the webpage code itself in which the execution flow and/or execution paths may change thus avoiding the need to reconfigure, upgrade and/or adjust the proxy server.

Furthermore, as the CSWE executes the web page code in parallel to the TWE and issues the client side requests to the proxy server, the proxy server allows the CSWE to run the web application client side code natively thus maintaining the user experience for the user of the CSWE. Executing natively at the client device may also allow the CSWE to take advantage of the personalized information of the user.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable medium may be a computer readable signal medium or a computer readable storage medium. Any combination of one or more computer readable medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer readable program instructions described herein can be downloaded to respective computing/processing devices from a computer readable storage medium or to an external computer or external storage device via a network, for example, the Internet, a local area network, a wide area network and/or a wireless network.

The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

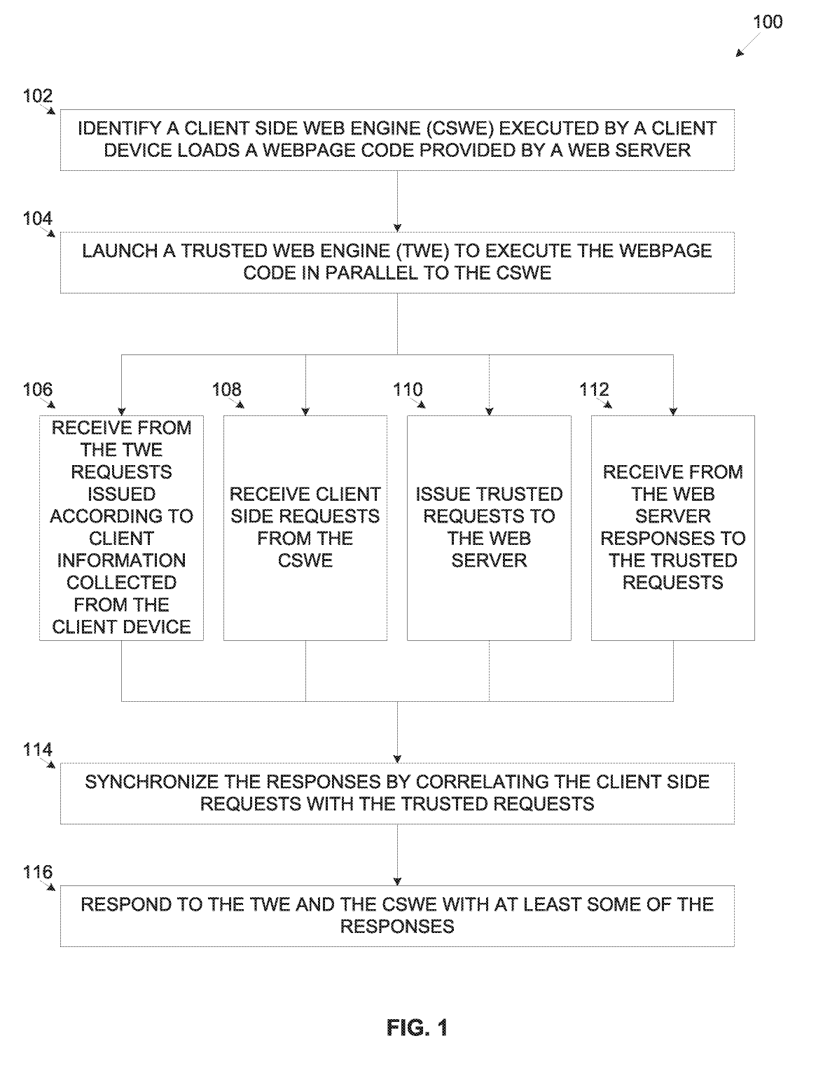

Referring now to the drawings, FIG. 1 illustrates a flowchart of an exemplary process for protecting a web server by utilizing a proxy server to execute a trusted web engine, according to some embodiments of the present invention. A process 100 may be executed to protect a web server providing dynamic webpage content, for example, an interactive web page, a web application and/or the like to one or more CSWEs executed by one or more untrusted client devices. The web server is protected by a proxy server that utilizes a TWE executing the client side code of the dynamic webpage comprising, for example, HTML, JavaScript, CSS and/or the like in parallel to execution of the client side code at the CSWE and directing only trusted requests (e.g. from the TWE) to the web server. While the process 100 may be applied for protecting a plurality of web servers providing a plurality of dynamic webpages to a plurality of client devices, for brevity the process 100 is described for a single web server providing code for executing a single webpage to a single client device.

The proxy server utilizes the TWE to emulate execution of the web page code by executing the webpage code and issuing trusted requests to the web server for interacting with the dynamic webpage. The CSWE executing the webpage code in parallel to the TWE, issues client side request such as, for example, the HTTP requests to the proxy server. Each of the client side requests as well as the trusted request may typically include one or more components, for example, an HTTP method, a protocol, a header(s), a body, a URI path, a URI parameter, cookie/s and/or the like.

In order for the TWE to accurately emulate the execution flow of the webpage code at the CSWE, the proxy server may collect client information from the client device, for example, interaction of a user using the client device with the dynamic webpage content, operational information of the CSWE, configuration information of the client device, the trigger of relevant methods and/or events, and/or the like. The proxy server may then provide the collected client information to the TWE to execute the webpage code accordingly.

In case one or more of the client side requests are not emulated by the TWE hence no corresponding trusted request is issued to the web server, the proxy server may determine validity of the client side request(s) against trusted components stored in a trusted components record. The trusted components record may include global trusted components and/or session trusted components. In case the proxy server determines the client side request(s) is valid, the proxy server may construct trusted request(s) based on the client side request(s) and issue it to the web server. In case the proxy server determines the client side request(s) is not valid, the proxy server may refuse the client side request(s). Naturally, the proxy server does not forward any of the client side request(s) to the web server.

The proxy server receives from the web server responses to the trusted request and responds with at least some of the responses to both the TWE and the CSWE. The proxy synchronizes the responses to both the TWE and the CSWE by correlating between at least some of the client side requests and the trusted requests using identification information (tagging) injected into one or more of the client side requests to identify a context of the client side request(s). The identification information may be injected to the client side request(s) based on instructions and/or directions of the proxy server embedded in one or more responses to one or more previous client side requests.

Since the proxy server forwards to the web server only trusted requests originating from the TWE and responds to the CSWE with responses received from the web server in response to the trusted requests, no direct communication is established between the (untrusted) client device and the web server.

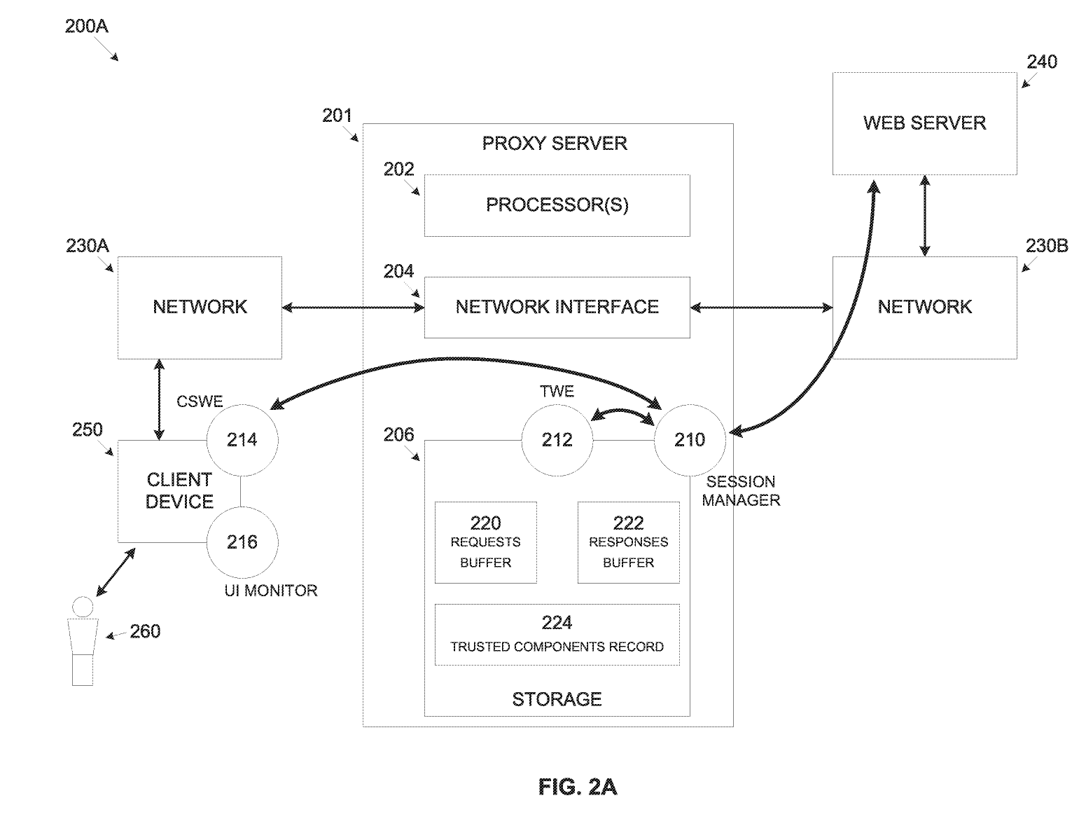

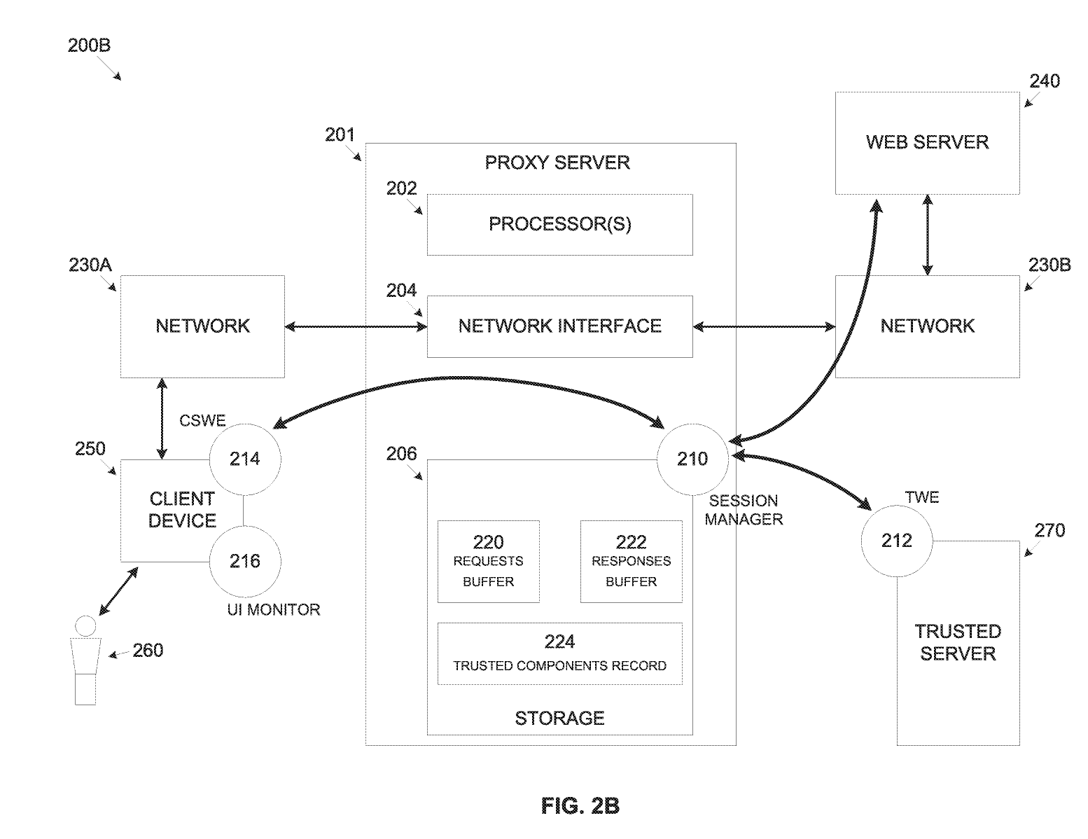

Reference is also made to FIG. 2A and FIG. 2B, which are schematic illustrations of exemplary systems for protecting a web server by utilizing a proxy server to execute a trusted web engine, according to some embodiments of the present invention. A system 200A for executing a web server protection process such as the process 100 comprises a proxy server 201, and a web server 240 and a client device 250 associated with a user 260. The proxy server 201, for example, a server, a processing node, a cluster of processing nodes and/or the like includes a processor(s) 202 for executing the process 100, a network interface 204 for connecting to one or more networks 230 and a storage 206. Optionally, the proxy server may be implemented as one or more remote services for example, a cloud service, a Software as a Service (SaaS), a Platform as a Service (PaaS) and/or the like.

The network interface 204 may provide one or more network interfaces, for example, a Local Area Network (LAN), a Wireless LAN (WLAN) (e.g. Wi-Fi), a cellular network interface and/or the like for connecting to one or more networks 230, for example, a network 235A for communicating with the client device 250 and/or a network 235B for communicating with the web server 240. The processor(s) 202, homogenous or heterogeneous, may be arranged for parallel processing, as clusters and/or as one or more multi core processor(s). The storage 206 may include one or more non-transitory persistent storage devices, for example, a Flash array, a Solid State Disk (SSD) and/or the like. The storage 206 may further be utilized through one or more volatile memory devices, for example, a Random Access Memory (RAM) device used to store program code downloaded from one or more remote locations over the network interface 204.

The processor(s) 202 may execute one or more one or more software modules, wherein a software module may be, for example, a process, an application, an agent, a utility, a script, a plug-in and/or the like comprising a plurality of program instructions stored in a storage such as the storage 206 and executed by one or more processors such as the processor(s) 202. The processor(s) 202 may execute a session manager 210 comprising one or more software modules for executing the process 100 to protect the web server 240 during the dynamic webpage interaction with the client device 250. The processor(s) 202 may further execute a software module TWE 212, for example, a stripped down web browser comprising only essential modules and/or components required for emulating in a trusted manner the execution of the webpage code at the client device 250. The TWE 212 may be, for example, a proprietary web browser, an open source based web browser (e.g. Chrome) and/or the like.

The session manager 210 and the TWE 212 may communicate with each other using a messaging mechanism allowing messages exchange between software modules, processes, applications, agents and/or the like. The messaging mechanism may be utilized through one or more available services, for example, an Operating System (OS) service, a commercially available service, a proprietary service and/or the like. The session manager 210 and/or the TWE 212 may employ one or more delivery policies, for example, push, pull and/or a combination thereof. Optionally, a heartbeat message is exchange at pre-defined time intervals to verify proper communication between the session manager 210 and the TWE 212.

One or more local records data may be locally stored in the storage 206 to be available to the processor(s) 202 and in particular to the session manager 210 and/or the TWE 212 for controlling the communication with the web server 240. The local records, for example, a requests buffer 220, a responses buffer 222 and/or a trusted components record 224 may be utilized through one or more data structures, for example, a database, a buffer, a cache, a queue, a list and/or the like. The requests buffer 220 may be used to temporarily store trusted requests issued by the session manager 210 to the web server 240. The responses buffer 222 may be used to temporarily store responses received from the web server 240 in response to the trusted requests. The trusted components record 224 may include one or more trusted requests issued to the web server 240. The trusted components record 224 may also include one or more of a plurality of trusted components, for example, an HTTP method, a protocol, a header, a body, a URI path, a URI parameter, an HTTP cookie and/or the like. The trusted components record 224 may include global trusted requests and/or components that may be typically, previously and/or recently used in trusted requests issued to the web server 240. The trusted components record 224 may also include session trusted requests and/or components used for one or more of the trusted requests during the current session held between the session manager 210 and the web server 240. Optionally, one or more of the trusted components are created according to one or more trusted components rules that may be generated by analyzing the client side request and/or the trusted requested issued by the TWE. The analysis may include for example, one or more machine learning algorithms that may be applied to the client side request and/or the trusted requested to identify valid trusted components as well as invalid and potentially malicious components.

Optionally, the proxy server 201 executes the session manager 210 for example as, a cloud service, Software as a Service (SaaS), a Platform as a Service (PaaS) and/or the like.

Optionally, as shown for a system 200B, the TWE 212 is executed by a trusted server 270, for example, a server, a processing node, a cluster of processing nodes and/or the like includes. Optionally, the trusted server 270 is implemented as one or more remote services for example, a cloud service, Software as a Service (SaaS), a Platform as a Service (PaaS) and/or the like. The TWE 212 executed by the trusted server 270 may communicate with the session manager 210 over one or more of the networks 230, for example, the network 230B.

The web server 240 serves the user 260 using the client device 250 with the dynamic webpage content by providing the webpage code executed by a CSWE 214 software module at the client device 250 with, for example, a web browser such as, for example, Firefox, Chrome, Edge, Internet Explorer (IE), an HTTP enabled mobile application and/or the like residing on the client device 250. The client device 250 may be for example, a Smartphone, a tablet, a smart watch, a laptop, a desktop, a work station and/or the like. The CSWE 214 may communicate with the session manager 210 over one or more of the networks 230, for example, the network 230A.

The client device 250 may include one or more human-machine interfaces, for example, a keyboard, a pointing device, a touch surface, a display, an audio interface and/or the like for interacting with the user 260. For example, the user 260 may be presented with a graphic user interface (GUI) utilized through the human-machine interface(s). The client device 250 may further execute a software module UI monitor 216 for monitoring interaction of the user 260 with the dynamic web page content presented by the CSWE 214. The UI monitor 216 may communicate with the session manager 210 and/or the TWE 212 over one or more of the networks 230, for example, the network 230A to provide the recorded user interaction to the TWE 212 in order to allow the TWE 212 to accurately emulate the execution flow of the webpage code at the CSWE 214. The UI monitor 216 may also communicate with the session manager 210 and/or the TWE 212 through the CSWE 214. Additionally and/or alternatively, the UI monitor 216 is implemented as an add-on software module, for example, a plug-in, a script and/or the like applied to the CSWE 214. The add-on software module(s) may also be provided to the CSWE 214 by the session manager 210, for example, embedded in one or more responses to one or more previous client side requests. The add-on software module(s) may also be applied to the CSWE 214 through an SDK and/or embedded in the CSWE 214 software package.

As shown at 102, the process 100 starts with the session manager 210 identifying that the CSWE 214 loads the webpage code of a dynamic webpage provided by the web server 240. Since the CSWE 214 is not directly communicating with the web server 240, i.e. the proxy server 210 isolates the web server 240 from the CSWE 214, the request of the CSWE 214 to load the webpage code may be relayed through the session manager 210. The session manager 210 may communicate with the web server 240 to receive the webpage code and provide it to the CSWE 214.

As shown at 104, the session manager 210 initiates one or more TWEs such as the TWE 212 to execute the same webpage code provided to the CSWE 214 such that both the TWE 212 and the CSWE 214 execute the same webpage code in parallel.

Due to the parallel operation of the CSWE 214 and the TWE 212 executing the same webpage code provided by the web server 240, two or more of steps 106, 108, 110 and/or 112 of the process 100 may take place at random order with respect to each other, simultaneously and/or at any sequence.

As shown at 106, the session manager 210 receives from the TWE 212 requests generated according to client information collected from the client device 250. The TWE 212 executes the webpage code in parallel (simultaneously) to the CSWE 214 to emulate execution of the webpage code as executed by the CSWE 214. The TWE 212 may emulate webpage code execution for complex, dynamic and/or user interaction intensive webpages. Each of the TWE 212 may emulate multiple tabs (navigation pages) during the current session the CSWE 214 holds with the web server 240 through the proxy server 201.

The client information may include, for example, interaction of the user 260 with the CSWE 214, operational information of the CSWE 214, configuration information of the client device 250 and/or the like. The client information may further include and/or define one or more relevant methods and/or events, for example, a user interaction trigger at the CSWE such as, for example, a key press, a mouse move and/or the like. One or more of the methods, events and/or triggers may further be associated with one or more context parameters, for example, a date, a time, a location and/or the like. The session manager 210 may communicate with the UI monitor 216 to collect the interaction of the user 260 with the webpage content presented by the CSWE 214 executing the webpage code. Typically, the CSWE 214 presents the webpage content to the user 260 through the GUI provided through one or more of the human-machine interfaces of the client device 250. The UI monitor 216 may detect one or more actions the user 260 makes while interacting with the webpage content presented by the CSWE 214, for example, a page load, an item selection, a touch location, a cursor hoovering location, a text input and/or the like. The UI monitor 216 may log the collected user interaction of the user 260 and transmit the collected user interaction to the session manager 210 that relays the collected user interaction to the TWE 212. The UI monitor 216 may further detect and collect one or more triggers and/or events that take place during the webpage (client side) code execution by the CSWE 214. The events and/or triggers may define, for example, a resource load and state event (e.g. image, scripts etc.), a screen orientation change, a back/forward/history navigation command, a resolution change, a location change, a page load and state events, and/or the like.

Moreover, the client information collected by the session manager 210 may include one or more operational parameters of the CSWE 214, for example, a personalization parameter stored for the user 260 such as, for example, a cookie, a favorite tag, a history entry and/or the like. The client information collected by the session manager 210 may further include one or more configuration parameters of the client device 250, for example, a computation capacity, a storage capacity, a display size, a display resolution, a battery capacity and/or the like. The session manager 210 may receive the operational parameter(s) of the CSWE 214 and/or the more configuration parameters of the client device 250 from the CSWE 214 and/or from the UI monitor 216.

The session manager 210 may provide the collected client information to the TWE 212 that may use the client information to emulate more accurately the execution flow of the webpage code as executed by the CSWE 214. For example, based on the user interaction received as part of the client information, the TWE 212 may be adapted to execute only the actions as initiated by the user 260 interacting with the CSWE 214. In another example, the TWE 212 may be adapted to emulate the webpage code as executed on a specific display size, for example, 5.5″, 16″ and/or the like. The display size may affect the webpage content and hence the webpage code execution. By applying the client information and/or part thereof while executing the webpage code, the TWE 212 may significantly increase the similarity of the execution flow of the webpage code as executed by the CSWE 214. This may allow preventing and/or reducing redundant effort in emulating all possible interaction options that may be otherwise required in case the user interaction is not available. This may further reduce latency in the emulation of the CSWE 214 execution and hence support an improved user experience for the user 260. Moreover, executing the TWE 212 with the client information and/or part thereof may allow taking advantage of the personal information associated with the user 260, for example, the cookie(s), the favorites list, the history list and/or the like that. This may accelerate execution of the webpage code compared to a scenario in which the client information is not available to the TWE 212.

As shown at 108, the session manager 210 receives a plurality of client side requests originating from the CSWE 214. The client side requests are issued by the CSWE 214 to request for updated data following one or more actions taken by the user 260 interacting with the CSWE 214 while executing the webpage code to present the associated webpage content to the user 260. In order to isolate the web server 240 from potentially untrusted clients, the client side request issued by the CSWE 214 are directed to the proxy server 201 executing the session manager 210 to determine validity of each of the received client side messages.

In some scenarios, the TWE 212 may experience difficulties to emulate the webpage code execution as executed by the CSWE 214 since the TWE 212 may be unaware of the context in which the CSWE 214 executes the webpage code.

One such exemplary scenario may occur when the webpage code includes JavaScript code which emits HTTP calls to the web server (i.e. XHR, AJAX, etc.), or when the webpage code embeds HTML iframes and/or pop-up windows that interacts with the main frame or each other. While executing the JavaScript code, one or more inner-page frames (pages) may be initiated from a top frame (page). Wherein the top frame is a top level page that requires a dedicated browser instance such as the CSWE 214 and/or the TWE 212 and the inner-page frames are pages or frames initiated from the top-page and are hence associated with the browser instance executing the top frame. The top frame may interact with one or more of the inner-page frames such that the top frame and the inner-page frames are inter-dependent. While the CSWE 214 is fully aware of the context, i.e. the inter-dependence, the TWE 212 may not be aware of such dependency by simply monitoring the client side requests issued by the CSWE 214.

In another such exemplary scenario, the TWE 214 may inaccurately emulate the webpage code execution as executed by the CSWE 214 due to responses caching, in particular for cached responses that comprise JavaScript and/or HTML. The CSWE 214 may use one or more cached responses previously received from the web server 240 (through the session manager 210) that are locally stored at the client device 250. The CSWE 214 may use the cached response(s) rather than using newly received response(s). The TWE 212 however, may not maintain the cached responses in the same manner as the CSWE 214. This may lead to a difference in the execution flow between the CSWE 214 and the TWE 212 that may gradually increase to a point of inconsistency between the webpage execution at the CSWE 214 and the TWE 212.

In order to improve the TWE 212 emulation accuracy to follow the webpage code execution as executed by the CSWE 214, the client information may be extended to include context information, in particular identification information extracted by the session manager 210 from one or more of the client side requests. The session manager 210 may analyze the identification information, instruct the TWE 212 to execute accordingly and/or provide the identification information to the TWE 212 to allow the TWE 212 to follow the webpage code execution flow as done by the CSWE 214. The identification information, for example, a unique identifier (ID) extracted by the session manager 210 may be injected, added and/or included in one or more of the client side requests using one or more implementations.

In one such exemplary implementation, the session manager 210 may manipulate (rewrite) one or more responses to one or more previous client side requests to include the identification information that the CSWE 214 includes in one or more subsequent client side requests. For example, assuming one or more previous response received from the web server 240 include URL(s). When responding to the CSWE 214, the session manager 210 may rewrite (manipulate) one or more of the URLs to embed (add) the identification information as a part of the URL(s). When the CSWE 214 issues one or more subsequent client side requests using the manipulated URL, the session manager 210 may extract the identification information from the manipulated URL and provide it to the TWE 212. The TWE 212 may thus use the identification information to maintain the context of the execution flow as executed by the CSWE 214.

In another example, the session manager may embed (add) one or more client side scripts, for example, beacon scripts into one or more responses to the CSWE 214. The client side scripts applied to the CSWE 214 may inject the identification information into one or more of the client side requests. The beacon script may execute in all page frames (i.e. HTTP responses with HTML code executed by the CSWE 214 and the TWE 212) and help identify when a frame is executed within another frame (e.g. iframe situation, pop-up window, etc.) and send the identification information to the session manager to help correlation of the client side requests with the trusted requests in order for the TWE 212 to correctly emulate the responses for the client side requests.

In another exemplary implementation, the session manager 210 may include one or more client side scripts, for example, a JavaScript that are executed by the CSWE 214. While executed by the CSWE 214, the client side scripts may inject the identification information into one or more subsequent client side requests.

In another exemplary implementation, the client side scripts injected by the session manager 210 may load one or more alternate functions to replace common function(s) (e.g. XMLHttpRequest( ) createElement( ) etc.) used by the CSWE 214 to generate the client side requests. The alternate function(s) may be adapted to inject and/or include the identification information in one or more subsequent client side requests.

In another exemplary implementation, the session manager 210 may rewrite one or more responses to replace one or more function calls with alternate function calls adapted to inject the identification information into one or more of the subsequent client side requests issued by the CSWE 214.

In another exemplary implementation, the session manager 210 may manipulate (rewrite) one or more responses to replace one or more function calls with function calls that are numbered and/or tagged distinctively. This may allow the session manager 210 to distinguish the function calls even amongst different function calls to the same function to support synchronization of the code execution flow at the TWE 212.

In another exemplary implementation, the identification information may be injected to the client side requests by one or more of the add-on software modules, for example, the script, the plug-in and/or the like that are applied to the CSWE 214.

Furthermore, the session manager 210 may interact with the add-on software module(s) to instruct the injection of the identification information. The add-on software module(s) may be used to tag dynamically one or more of the client side requests generated by the CSWE 214. The add-on software module(s) may also be applied to the TWE 212 such that the session manager 210 may be able to track and/or correlate between the trusted requests issued by the TWE 212 and the client side requests issued by the CSWE 214. In another example, the session manager 210 may inject into the response(s) one or more client side rewriting scripts that may rewrite the URL(s) as instructed by the session manager 210.

Using one or more of the implementations described herein above, the identification information, for example, a frame ID and/or a tag may be assigned, for example, to each of the frames (top frame and/or inner-page frame(s)) initiated by the CSWE 214. The identification information may further include a unique frame ID to each of the inner-page frames and a frame ID that identifies the parent frame. The frame ID may be injected into one or more of the client side requests to identify the frames hierarchy and correlate between each of the client side requests and the frame it relates to. The frame ID may then be used by the session manager 210 to distinguish between client side requests originating from the top frame and client side requests originating from the inner-page frame(s). The session manager 210 may provide the frame ID(s) in correlation to their originating frames to the TWE 212. This may allow the TWE 212 to accurately associate the client side requests with the frames of the session held with the web server 240 and accurately emulate the execution flow of the webpage code as executed at the CSWE 214.

The identification information may include one or more additional identifiers, for example, a request ID that may be assigned to each of the client side requests. Another exemplary identifier that may be assigned to one or more of the client side requests is a session ID identifying the session of the CSWE 214 the client side request(s) are associated with.

Moreover, the webpage code executed simultaneously by the CSWE 214 and the TWE 212 may apply web sockets in which a plurality of client side requests may be issued concurrently independent of the responses received from the web server 240. The session manger 210 using the TWE 212 may trace, follow and/or emulate the web socket interaction by analyzing the client information, in particular the identification information extracted from the client side requests. The session manager 210 may analyze the identification information extracted from the client side requests originating from the CSWE 214 and the trusted requests from the TWE 212. Based on the analysis, the session manager 210 may correlate socket messages between the TWE 212 and the CSWE 214 in a buffered manner where every pre-defined number of bytes and/or pre-defined time period the session manager 210 compares a respective section of the socket stream in order to determine validity of the CSWE messages.

Optionally, the session manager 210 may apply one or more compensation mechanisms to handle discrepancies in code execution flows between the CSWE 214 and the TWE 212. For example, the CSWE 214 and the TWE 212 may issue an un-even number of calls to the same function as result of, for example, the fact that the CSWE 214, for example, Firefox, IE, chrome and/or the like apply one or more different plug-in modules than the TWE 212. The session manager 210 may resolve the un-even calls discrepancy by, for example, maintaining a count of references of calls to the same function and their caller (referred to as “callee” in JavaScript) and/or replacing the callers in the responses with tagged callers which could be distinctively identified.

Furthermore, the session manager 210 may manipulate one or more of the responses to adjust a code segment included in the response(s) such that when the adjusted code segment is executed it may provide the context information, in particular the identification information. For example, in case one or more of the responses includes JavaScript, HTML iframes and/or the like, the session manager 210 may manipulate the code to include additional instructions executed when the code is executed. For example, the session manager 210 may manipulate the JavaScript to add a code segment that when executed issues a unique client side request identifying, for example, the JavaScript code, an ID of the response in which the JavaScript code was received and/or the like. Assuming the CSWE 214 executes the JavaScript code using a cached response instead of requesting the JavaScript code again from the web server 240. When the CSWE 214 executes the JavaScript code, the added code segment will generate the unique client side request. The session manger 210 may analyze the unique client side request and identify it is associated with the manipulated JavaScript code. The session manager 210 may therefore determine that the JavaScript code is executed from a cached response and may instruct the TWE 212 to execute the same JavaScript code to emulate the execution flow at the CSWE 214.

In addition, the session manager 210 may instruct the TWE 212 to apply a cache policy that is typically employed by the CSWE 214 according to the type of the CSWE 214, for example, Firefox, Chrome, Edge, Internet Explorer (IE), Safari, Opera and/or the like. Optionally, in case the session manager 210 detects a deviation and/or a discrepancy between the execution flow of the CSWE 214 and the TWE 212, the session manager 210 may instruct the CSWE 214, the TWE 212 and/or both to erase the cache content and/or force load of fresh content. This may allow the CSWE 214 and the TWE 212 to continue the webpage code execution from a substantially similar point. The session manage 210 may further instruct the CSWE 214 to disable its cache such that the CSWE 214 uses the latest received responses.

As shown at 110, the session manager 210 issues to the web server 240 a plurality of trusted requests. The trusted requests may originate from the TWE 212 executing the webpage code according to the client information 0. Optionally, one or more of the trusted requests may be a similar request extracted from the trusted components record 224. In case the session manager 210 identifies that a certain client side request is similar to a previously issued trusted request, the session manager 210 may forward to the web server 240 the extracted trusted request corresponding to the certain client side request. Additionally, one or more of the trusted requests may be constructed by the session manager 210 based on one or more of the client side requests received from the CSWE 214 in case no corresponding trusted request was received from the TWE 212 emulating the execution flow of the CSWE 214. The session manager 210 may store each of the trusted requests in the requests buffer 220. The session manager 210 may further update the trusted components record 224 with one or more components of the trusted request as it is approved for use during the current and/or future sessions with the web server 240.

Since the TWE 212 emulates the execution flow of the CSWE 214 executing the webpage code provided by the web server, typically, most of the client side requests received from the CSWE 214 may be emulated by the TWE 212. However, since the TWE 212 may sometimes not precisely emulate the execution of the webpage code as executed by the CSWE 214, one or more of the client side requests may not be emulated by the TWE 212. In such case, the session manager 210 may first check validity of the client side request(s) as described herein after and in case the client side request(s) is valid, the session manger 210 may construct one or more trusted requests based on the client side request(s) having no corresponding trusted requests resulting from the TWE 212 emulation. The session manager 210 may construct the trusted request using one or more trusted components stored, for example, in the trusted components record 224 that are approved components for the session held with the web server 240.

Optionally, one or more of the trusted requests may be similar requests extracted from the trusted components record 224. In case the session manager 210 identifies that a certain client side request is similar to a previously issued trusted request, the session manager 210 may forward to the web server 240 the extracted trusted request corresponding to the certain client side request.

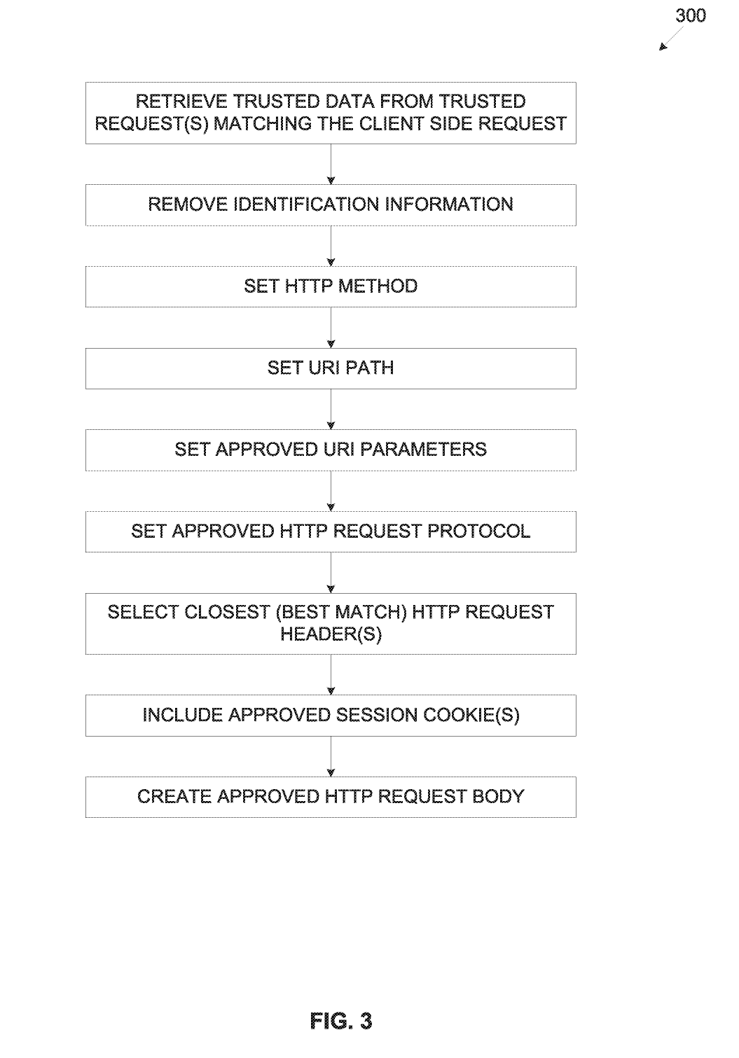

Reference is now made to FIG. 3, which is a flowchart of an exemplary process for constructing a trusted request, according to some embodiments of the present invention. An exemplary process 300 may be executed by a session manager such as the session manager 210 to construct a trusted request, for example, an HTTP request based on a client side request received from a CSWE such as the CSWE 214 in case the client side request is not precisely emulated by a TWE such as the TWE 212. The session manager 210 may construct the trusted request by selecting an approved HTTP method from the trusted components record 224. The session manger 210 may select the HTTP method that best matches (corresponds) the HTTP method of the client side request according to an HTTP method included, suggested and/or referenced in the un-emulated client side request. The session manager 210 may further select the approved HTTP method according to HTTP methods typically and/or generally used with the type of request as the un-emulated client side request.

Similarly, the session manger 210 may select from the trusted components record 224, one or more additional approved components, for example, An HTTP protocol, a URI path, a URI parameter and/or a session cookie for constructing the trusted request. The selected approved components may include, for example, components included in trusted requests issued by the TWE 212 during the current session of the CSWE 214, components included in trusted requests issued by the TWE 212 during previous (past) sessions and/or generally used components. The session manager 210 may store the constructed trusted request(s) in the trusted components record 224 for future use during the current session of the CSWE 214 and/or future session of the CSWE 214 and/or other CSWE such as the CSWE 214 executed on other client devices such as the client devices 250 used by one or more users such as the user 260.

The session manger 210 may remove the identification information one or more of the trusted components may comprise. For example, assuming the session manger 210 determines a certain client side request does not match any of the trusted requests issued by the TWE 212. The session manager may check the trusted components record 224 and identify a (semantically) similar trusted request previously issued by the TWE 212 and stored in the trusted components record 224. The session manager 210 may construct use the stored trusted request to replace the certain client side request. However before forwarding the trusted request to the web server 240, the session manager 210 may first remove the identification information, for example, the request ID, the frame ID and/or the like that should not be sent to the web server 240.

It should be emphasized that none of the client side request, either matching to an emulated request by the TWE 212 or not, are forwarded to the web server 240. The trusted requests forwarded to the web server 240 are either trusted requests originating from the TWE or trusted requests constructed by the session manager 210 based on the valid un-emulated client side requests.

Reference is made once again to FIG. 1.

As shown at 112, the session manager 210 receives from the web server 240 a plurality of responses to the trusted requests. Each of the responses may be associated with one or more of the trusted requests. The session manager 210 stores each of the received responses received from the web server 240 in the responses buffer 222.

In order to protect the web server 240 from receiving untrusted and potentially malicious requests from the CSWE 214, the session manager 210 determines validity of each of the client side requests and generates an appropriate response for each of the client side requests. As part of the process 100, the session manager 210 may therefore apply a process for validating each of the client side requests, issuing the trusted requests and creating a client response queue of responses to the CSWE 214 comprising responses associated with the client side requests. As described before, the session manager 210 may further construct one or more trusted requests in case the session manager 210 receives from the CSWE 214 client side request(s) that have no corresponding trusted request received from the TWE 212. This may result from the fact that the TWE 212 may sometimes not precisely emulate the execution flow of the webpage code as executed by the CSWE 214.

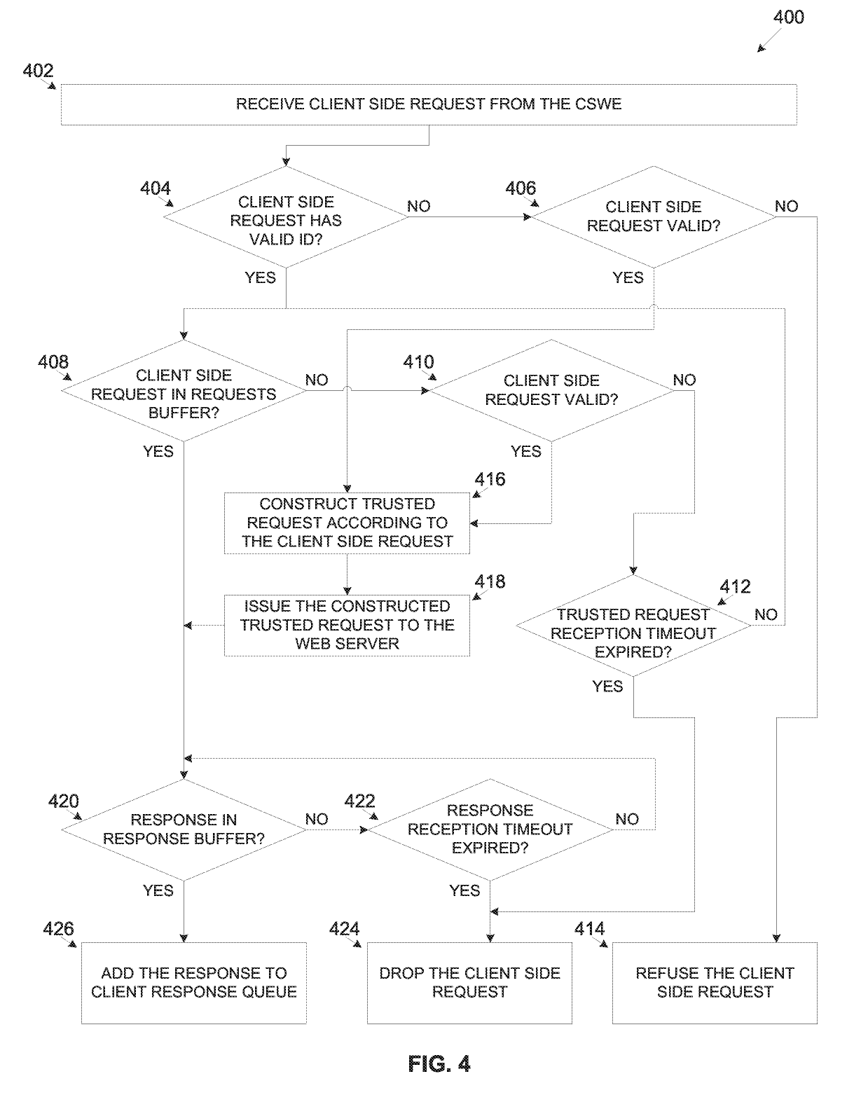

Reference is now made to FIG. 4, which is a flowchart of an exemplary process for processing a client side requests received from a client device, according to some embodiments of the present invention. An exemplary process 400 may be applied by a session manager such as the session manager 210 to process client side request(s) received from a CSWE such as the CSWE 214 that are directed to a web server such as the web server 240 while the CSWE 214 executes webpage code provided by the web server 240. A TWE such as the TWE 212 executes the same webpage code in parallel to the CSWE 214. Naturally, the process 400 may be repeated for processing a plurality of client side requests.

As shown at 402, the session manager 210 receives a client side request from the CSWE 214 executing webpage code provided by the web server 240.

As shown at 404, that is a decision point, the session manager 210 checks the identification information, for example, a session ID of the client side request to verify the client side request is issued by the CSWE 214 as part of the current session with the web server 240. The session ID may be typically assigned to each of the client side requests by the add-on software module(s) applied to the CSWE 214 as part of the webpage code execution in order to associate each client side request with its respective session. In case the session manager 210 determines that the session ID of the client side request is valid the process 400 branches to step 408, otherwise the process 400 branches to step 406.

As shown at 406, that is a decision point, the session manager 210 determines validity of the received client side request in order to avoid sending untrusted and potentially malicious requests to the web server 240. Since the received client side request may not have a valid session ID, the session manager 210 may fail to associate the received client side request with the execution flow of the current session held with the web server 240. The session manager 210 may therefore analyze the components constituting the client side request, for example, the HTTP method, the protocol, the headers, the body, the URI path, the URI parameter(s), the session cookie and/or the like. The session manager 210 may check the validity of the client side requests component(s) against a plurality of trusted components stored in a trusted components record such as the trusted components record 224. The trusted components record 224 may include a session trusted components record comprising trusted components approved for the current session of the CSWE 214 with the web server 240. The session trusted components are components having a valid session ID that were approved by the session manager 210 during the current session. The trusted components record 224 may further include a global (general) trusted components record comprising trusted components approved during one or more past session with the web server 240 specifically and/or with one or more other web servers such as the web server 240. The session manager 210 may further check if the client side request has a corresponding (similar) previously received client side request that was validated and/or to a corresponding previous trusted request. The session manager 210 may check this by searching, for example, the trusted components record 224 that may be used to store the validated previous client side requests and/or the previous trusted requests. In case the session manager 210 determines that the client side request is not a valid request, the 400 branches to step 414, otherwise the process 400 branches to step 416.

In some scenarios, the session manager 210 may be unable to validate one or more of the component constituting the client side request, in particular when unstructured user input is included, for example, a free text field and/or the like. The free text field may be used to attack the web server 240. In some cases, in order to facilitate the attack, a potential attacker may manually enter malicious code in the text field(s) which without specific handling may be duplicated by the TWE 212 and the derived trusted request might be sent to the web server 240. To overcome this, the TWE 212 may further analyze one or more parameter(s) and/or attribute(s) of the text field(s) presented by the executed webpage code to identify a discrepancy in the collected user actions with one or more of the parameters, attributes and or attack signatures that may indicate that user action containing the text may be potentially malicious.

For example, assuming the webpage code includes a text field that may be limited to a certain number of characters, for example, 15. In case the TWE 212 identifies that a certain user action (collected through the UI monitor 216) includes an assignment of this text field with a higher number of characters than the limit, for example, 50 characters, the TWE 212 may determine that the certain user action is invalid. In another example, the session manager 210 may determine that the text collected through the UI monitor 216 and delivered to the TWE 212 is different than the text detected in a respective client side request issued by the CSWE 214 and thus does not match a corresponding trusted request issued by the TWE 212. In another example, the session manager 210 may instruct the TWE 212 to perform a malicious signature validation (e.g. SQL Injection, Cross Side Scripting, etc.) and/or a user defined validation (e.g. “numeric value only”, etc.) compared to the text and/or user interaction collected by the UI monitor 216. The TWE 212 may then avoid processing of invalid text detected in the client side requests thus not issuing a trusted request corresponding to the client side request(s) comprising the invalid text causing the session manager 210 to reject the respective client side request(s).

Another user input components that may present a difficulty for the session manager 210 to validate is an uploaded file. The TWE 212 may detect one or more file upload components in the webpage code (such as form with <input type=“file”>, dropzone elements, JavaScript file upload, and/or the likes) and may further identify the user 260 triggered the upload component(s) by analyzing the interaction collected by the UI monitor 216. In such case, the TWE 212 may emulate a “dummy” stub file that may be attached to the respective trusted request issued by the TWE 212. The TWE 212 may thus indicate the session manager 210 to look for a corresponding client side request and when detected, issue the respective trusted request in which the stub file replaced with an actual file provided by the corresponding client side request.

The session manager 210 may further take one or more actions for validating the uploaded file, for example, apply an anti-virus tool to scan the uploaded file, apply an anti-malware tool to scan the uploaded file, apply an anti-spyware tool to scan the uploaded file and/or the like.

In order to enhance the protection of the web server 240, the session manager 210 may further detect, analyze and validate external resources included in one or more of the client side requests. The external resources may include, for example, a JavaScript external resource URI, a Cascading Style Sheets (CSS) URI and/or the like where the URI is directed towards an external resource that is not within the domain of the web server 240. This may be a result of external links embedded in the webpage code that is processed by the CSWE 214. In such cases, the session manager 210 may extract the URI context by analyzing one or more of the responses. The session manager 210 may apply static HTML parsing and/or element analysis over one or more created Document Object Model (DOM) element created by a JavaScript code in the TWE 212. The session manager 210 may compare the external resource against to a list of approved external domain (by URL, Internet Protocol address, etc.), external resources (by, for example, file, hash and/or the like), CSS and/or HTML stored, for example, in the trusted components record 224. The session manager 210 may instruct the TWE 212 to process only the approved external resources. This may allow the session manager 210 to track unauthorized use of external untrusted code.

Optionally, the session manager 210 applies a monitoring mode in which one or more invalidated user input components are included in one or more of the trusted requests issued to the web server 240. The session manager 210 may forward the invalidated component(s) to the web server 240 in order to maintain serviceability to the CSWE 214 and avoid interruptions in the session. While the session manager 210 may not be able to validate the user input component(s) that are forwarded to the web server 240, the session manager may logging each such request and/or invalidated user component. The log may be used for one or more operations, for example, post event analysis, pattern learning to identify future user input components and/or the like.

Optionally, the session manager 210 may apply one or more validation rules that may be set for the web server 240. For example, a certain validation rule may indicate partial validation of the client side requests. The validation rule may direct the session manager 210, for example, to avoid checking certain one or more components and/or parameter of the client side request. For example, according to an exemplary validation rule, the session manager 210 may ignore a specific URI parameter when checking validity of the client side request. The validation rule(s) may be created by one or more programmers, for example, an Information Technology (IT) person of the operator of the web server 240, a programmer of the webpage and/or the like. The manager 210 may further provide a visual interface, for example, a Graphical User Interface (GUI) to allow the IT person to easily define one or more of the validation rules. The GUI may allow the programmer to directly access one or more of the webpage elements in order to identify the parameter(s) and/or attribute(s) of the webpage components and define one or more validation rules for one or more of the components. This may be useful to the programmer that may otherwise (without the GUI) need to investigate the components and/or the client side requests relating to the components at the coding level of the webpage, for example, HTML, a task that may be complicated and time consuming.

As shown at 408, that is a decision point, the session manager 210 checks if the received client side request has a corresponding trusted request (already) issued by the TWE 212 and forwarded by the session manager 210 to the web server 240. Since the TWE 212 emulates the execution flow of the webpage code by CSWE 212 with the same client information received from a UI monitor such as the UI monitor 216 and/or the CSWE 214 itself, it is expected that at least some of the client side requests have corresponding (similar) trusted requests issued by the TWE 212. Evidently, a client side request having a corresponding trusted request may not contain malicious content and may therefore not present a threat to the web server 240. The session manager 210 may search a requests buffer such as the requests buffer 220 to look for a request corresponding to the received client side request. In case the session manager 210 finds a corresponding trusted request in the requests buffer 220, the process 400 branches to step 420, otherwise the process 400 branches to step 410.

As shown at 410, that is a decision point, in case there is no corresponding trusted request in the requests buffer 220, the session manager 210 determines validity of the received client side request in order to avoid sending untrusted and potentially malicious requests to the web server 240. The session manager 210 may determine whether the received client side request is valid by applying the analysis as described in step 406. In case all the components constituting the client side request are trusted (approved) components the session manager 210 may determine that the client side request is valid and the process 400 branches to step 416. In case the session manager 210 determines that the client side request is not a valid request, the 400 branches to step 412.

As shown at 412, that is a decision point, the session manager 210 applies a trusted request reception timeout. Since the CSWE 214 and the TWE 212 may execute the webpage code concurrently, it is possible that one or more of the client side requests are issued by the CSWE 214 before a corresponding trusted request is issued by the TWE 212. In order to allow for a pre-defined request time period for the TWE 212 to issue the corresponding trusted request, the session manager 210 may apply the trusted request reception timeout. The session manager 210 may start a timer, for example, a timer task, a hardware timer, an operating system timer and/or the like with a pre-defined time period to set a trusted request reception timeout counting the pre-defined request time period. In case the pre-defined trusted request reception timeout does not expire, the process 400 returns to the step 408 to check if the corresponding trusted request was received from the TWE 212. In such case if the session manager 210 does not find a corresponding trusted request issued by the TWE 212 (step 408) the session manager 210 may skip analyzing validity of the client side request (step 410) since the step 410 was done before for the current client side request. In case the trusted request reception timeout expires, the process 400 branches to step 424.

As shown at 414, the session manager 210 refuses the received client side request that is determined to be invalid as it may potentially be a harmful (malicious) request). Naturally, the invalid client side request is not forwarded to the web server 240.

As shown at 416, the session manager 210 constructs a trusted request based on the received client side request by applying a trusted request construction process such as the process 300. In order to maintain high isolation of the web server 240 from the CSWE 214, the session manager 210 constructs one or more trusted request for one or more client side requests even if the client side request(s) that are not emulated by the TWE 212 are determined to be valid. This means that even client side requests determined as valid are not directly forwarded to the web server 240. Instead trusted request(s) are constructed from the trusted components based on the client side request(s).

The session manger 210 may create one or more of the trusted components based on the client side requests received from the CSWE 214. For example, the session manger 210 may create one or more trusted cookies to replace cookie(s) generated by the web server 240 for the CSWE 214 executing the webpage code.

Using cookies is a methodology widely used to save information specific to the CSWE 214, the client device 250 and/or the user 260. The cookies allow saving client information at the client device side rather than at the web server 240 thus reducing storage resources of the web server 240. The cookie(s), for example, HTTP cookies are HTTP elements that are set either by an HTTP response or one or more client side scripts, for example, JavaScript. The cookie(s) is saved by the CSWE 214 according to one or more cookie saving rules attached to the cookie by the web server 240. Typically, the CSWE 214 may also send the cookie(s) back to the web server 240 in one or more subsequent requests according to the cookie sending rule(s). As the cookie(s) may be part of the HTTP communication between CSWE 214 and the web server 240, the cookie(s) may be used as an attack vector. Also, since the cookie(s) may have persistency settings and stored by the CSWE 214 after closing the current session, special consideration and handling may be required by the session manager 210 to protect the web server 240 from malicious cookie(s) while preserving the functionality of the cookie(s).

To overcome this, the session manager 210 may create a cookie repository comprising one or more trusted cookies for the CSWE 214. The cookie repository may be implemented as part of the trusted components record 224. Naturally, since the system 200A and/or 200B may serve a plurality of CSWEs such as the CSWE 214, a dedicated cookie repository may be created for each of the CSWEs 214. Every cookie set by the web server 240 in one or more response to the TWE 212 and/or by scripts running on the TWE 212 may be saved to the cookie repository created for the CSWE 214. Whenever a cookie is provided in a response from the web server 240, the session manager 210 may extract the cookie from the response and replace the web server provided cookie with a trusted cookie such that the trusted cookie is included in the response to the CSWE 214 and the TWE 212. The trusted cookie may comprise identification information identifying the CSWE 214 to associate the browsing session held by the CSWE 214 and the TWE 212 with the correspondent cookie repository.

The session manager 210 may send one or more cookies required for operation of the client side script(s) (as identified by their settings). However, the session manager 210 may ignore the cookie(s) in the client side requests. In case the current session is the first session of the CSWE 214 with the web server 240, in particular for executing the current webpage code, the session manager 210 may store the cookie(s) received from the web server 240 in the cookie repository. However, it is possible that the cookie(s) are available to the CSWE 214 from previous sessions in which the CSWE 214 communicated directly with the web server 240 before applying the proxy server 210. In such case the cookie(s) included in the client side request may not available in the cookie repository. The session manager 210 may therefore avoid including the cookie(s) in the constructed trusted request. The session manager 210 may further instruct the add-on software component(s) applied to the CSWE 214 to delete the cookie(s) such that the CSWE 214 needs to ask the web server 240 to re-generate the cookie(s), this time going through the proxy server 201 and the session manager 210.

As shown at 418, the session manager 210 issues the constructed trusted request to the web server 240.

As shown at 420, that is a decision point, the session manager 210 checks for a response received for the corresponding trusted request. The session manager 210 may search a responses buffer such as the responses buffer 222 to look for the response to the corresponding trusted request. In case the session manager 210 finds a response to the corresponding trusted request in the response buffer 222, the process 400 branches to step 426, otherwise the process 400 branches to step 422.

As shown at 422, that is a decision point, the session manager 210 applies a response reception timeout in order to allow the web server 240 to respond to the trusted request within a pre-defined response time period. Due to one or more reasons, for example, latency in communication between the proxy server 201 and the web server 240, computation load at the web server 240 and/or the like it is possible that a response to the trusted requests is delayed and is therefore not available in the responses buffer 222. The session manager 210 may start a timer, for example, a timer task, a hardware timer, an operating system timer and/or the like with a pre-defined time period to set a response reception timeout counting the pre-defined response time period. In case the pre-defined response time period does not expire, the process 100 returns to the step 420. However, in case the response reception timeout expires, the process 400 branches to step 424.

As shown at 424, the session manager 210 drops the client side request for which no corresponding trusted request was received from the TWE 212 within the pre-defined request time period, i.e. the trusted request reception timeout expired. The session manager 210 may also drop the client side request for which the corresponding trusted request was not responded by the web server 240.

As shown at 426, the session manager 210 adds the response received from the web server 240 for the corresponding trusted request to the client response queue to be provided to the CSWE 214.

Reference is made once again to FIG. 1.

As shown at 114, the session manager 210 synchronizes the client responses queue that comprises one or more of the responses received from the web server 214 to prepare the responses for transmittal to the CSWE 214. As part of the synchronization, the session manager 210 needs to correlate between each of the client side requests and a corresponding trusted request. Moreover, since any two or more of the steps 106, 108, 110 and/or 112 may take place at random order with respect to each other, simultaneously and/or at any sequence, the session manager 210 may need to synchronize the responses before providing them to the CSWE 214 and/or the TWE 212. For example, the session manager 210 may issue one or more trusted requests originating from the TWE 212 before receiving a corresponding (similar) client side request(s) from the CSWE 214. In another example, the session manager 210 may receive one or more client side request(s) from the CSWE 214 before a corresponding (similar) trusted request(s) is received from the TWE 212.

The session manager 210 may use the identification information, for example, the request ID, the frame ID(s), the tags and/or the like injected into the client side requests originating from the CSWE 214 and the trusted requests originating from the TWE 212 to correlate them with each other. The session manager 210 may use the request ID, for example, to correlate accurately between the trusted and the client side requests and arrange accordingly the associated responses to be sent to the CSWE 214 and the TWE 212. This may allow the session manager 210 to unequivocally identify each of the client side requests and/or trusted requests even in cases where multiple identical requests are issued by the CSWE 214 and/or the TWE 212 are received by the session manager 210 simultaneously or in close (timing) proximity.

The session manager 210 may further correlate the client side requests with the trusted requests according one or more other parameters, for example, the data included in the request such as the URL Path, URL query string parameters, Method (e.g. GET, POST, and or the like), From parameters in the request body, header information, unstructured data in the request body and/or the like, time proximity of the requests, an order of reception of the requests and/or the like. Unlike the existing methods for protecting the web server 240, the invention correlation is not relying solely on URL matching and may therefore solve the issue of mismatches between requests generated by different dynamically-generated instances of the CSWE 214.

As shown at 116, the session manager 210 responds to both the TWE and the CSWE 214 with the synchronized responses. In case the session manager 210 determined that one or more of the client side requests are invalid requests, the session manager 210 may respond to the CSWE 214 with a refusal to the invalid client side request(s). In order to maintain locality in time of the responses and/or the requests, after responding to the CSWE 214 with a specific response, the session manager 210 may remove the specific response and/or its associated trusted request(s) from the responses buffer 222 and the requests buffer 220 respectively.

As discussed herein above, in some scenarios, the session manager 210 may not receive one or more (delayed) responses to one or more of the client side requests (corresponding to trusted request(s)) from the web server 240 within the pre-defined response time period. This may result from one or more reasons, for example, the latency in communication between the proxy server 201 and the web server 240, the computation load at the web server 240 and/or the like. In such case, the session manager 210 may hold the respective client side request(s) until their associated responses are received from the web server 240 In order to avoid a situation in which the session of the CSWE 214 is paused for an unlimited and/or extended period of time, the session manager 210 may apply the response reception timeout. Therefore, in case the response reception timeout expires before one or more responses are received from the web server 240, the session manager 210 may drop the respective client side request(s) associated with the not received response(s).

The process 100 may be repeated for a plurality of cycles throughout the session held between the CSWE 214 and the web server 240.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant systems, methods and computer programs will be developed and the scope of the term dynamic web content is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A computer implemented method of protecting a web server by applying a trusted web engine (TWE) to execute a webpage code in parallel to a client side web engine (CSWE), comprising a proxy server executing a code for:
using a TWE to execute a code of a webpage provided by a web server;
issuing to said web server a plurality of trusted requests originating from said TWE;
receiving a plurality of client side requests originating from a CSWE executing said code of said webpage on a client device in parallel to said TWE;
receiving from said web server a plurality of responses to said plurality of trusted requests; and
sending to said CSWE at least some of said plurality of responses synchronized by correlating at least some of said plurality of client side requests with corresponding trusted requests of said plurality of trusted requests according to identification information injected into said at least some client side requests.

2. The computer implemented method of claim 1, wherein said TWE emulates execution of said code of said webpage by said CSWE according to client information received from said client device.

3. The computer implemented method of claim 2, wherein said client information comprises at least one member of a group consisting of: an interaction of a user associated with said client device with said code of said webpage, an operational parameter of said CSWE and a configuration parameter of said client device.

4. The computer implemented method of claim 1, wherein each of said plurality of trusted requests and each of said plurality of responses comprises at least one member of a group consisting of: a Hypertext Transfer Protocol (HTTP) method, a protocol, a headers, a body, a Uniform Resource Identifier (URI) path, a URI parameter and a session cookie.

5. The computer implemented method of claim 1, wherein said identification information associated each of said plurality of client side requests with an originating session frame initiated by said CSWE while executing said webpage code.

6. The computer implemented method of claim 1, wherein said identification information is injected into said at least some client side requests by embedding said identification information in at least one previous response sent to said CSWE.

7. The computer implemented method of claim 1, wherein said identification information is injected into said at least some client side requests by embedding at least one client side script in at least one previous response sent to said CSWE, said at least one embedded client side script creates said identification information.

8. The computer implemented method of claim 1, wherein said identification information is injected into said at least some client side requests by adjusting at least one code segment included in at least one previous response sent to said CSWE, said at least one code segment creates said identification information.

9. The computer implemented method of claim 1, wherein said identification information is injected into said at least some client side requests by at least one add-on software module applied to said CSWE, said at least one add-on software module is initiated to create said identification information.

10. The computer implemented method of claim 1, further comprising at least one cookie provided by said web server to said CSWE is replaced with a trusted cookie stored in at least one trusted components record of said proxy server, wherein said identification information further associates said at least one cookie with said trusted cookie.

11. The computer implemented method of claim 1, wherein at least one text field included in at least one of said plurality of client side requests is validated by comparing an actual text inserted in said at least one text field with a text included in said at least one client side request according to at least one attribute of said at least one text field, said actual text is collected by monitoring an interaction of a user associated with said client device with said code of said webpage.

12. The computer implemented method of claim 1, wherein at least one client side request is held by said proxy server until correlated with a corresponding one of said plurality of trusted requests received from said TWE.

13. The computer implemented method of claim 12, further comprising dropping said at least one held client side request in case said corresponding trusted request is not received from said TWE within a pre-defined timeout period.

14. The computer implemented method of claim 1, further comprising issuing to said web server at least one constructed trusted request such as said plurality of trusted requests, said at least one constructed trusted request is constructed based on at least one client side request not emulated by said TWE in case all components of said at least one client side request correspond to trusted components stored in at least one trusted components record of said proxy server.

15. The computer implemented method of claim 14, wherein said at least one trusted components record includes at least one global trusted component used for a plurality of sessions with said web server.

16. The computer implemented method of claim 14, wherein said at least one trusted components record includes at least one session trusted component used in at least one of said plurality of trusted requests.

17. The computer implemented method of claim 14, wherein said at least one trusted components record includes at least one rule based trusted component created according to at least one trusted component creation rule.

18. The computer implemented method of claim 14, wherein said at least one trusted components record is updated to include said at least one constructed trusted request.

19. The computer implemented method of claim 1, wherein said plurality of trusted requests and said plurality of responses are stored in at least one local record by said proxy server.

20. The computer implemented method of claim 19, further comprising:
removing, from said at least one local record, each of said plurality of trusted requests after responding to at least one client side request corresponding to said each trusted request, and
removing, from said at least one local record, at least one of said plurality of responses associated with said each removed trusted request.

21. The computer implemented method of claim 1, wherein said proxy server refuses to respond to at least one of said plurality of client side requests in case said at least one client request has no corresponding trusted request of said plurality of trusted requests.

22. A proxy server for protecting a web server by applying a trusted web engine (TWE) to execute a webpage code in parallel to a client side web engine (CSWE), comprising:
a program store storing a code; and
at least one processor coupled to said program store for executing said code, said code comprising:
code instructions to execute, using a TWE a code of a webpage provided by a web server;
code instructions to issue to said web server a plurality of trusted requests originating from said TWE to said web application server;
code instructions to receive a plurality of client side requests originating from a CSWE executing said code of said webpage on a client device in parallel to said TWE;
code instructions to receive from said web server a plurality of responses to said plurality of trusted requests; and
code instructions to send to said CSWE at least some of said plurality of responses synchronized by correlating at least some of said plurality of client side requests with corresponding trusted requests of said plurality of trusted requests according to identification information injected to said at least some client side requests.
